(19) United States
(12) Patent Application Publication
(10) Pub. No.: US 2007/0023236 A1
(43) Pub. Date: Feb. 1, 2007

(54) Wear-protected system for monitoring vehicle brakeshoe wear

(75) Inventors: Helmuth Ludwig, Gotzis (AT); Martin Schmid, Frastanz (AT)

Correspondence Address: THE FIRM OF KARL F ROSS, 5676 RIVERDALE AVENUE, PO BOX 900, RIVERDALE (BRONX), NY, 10471-0900, US

(73) Assignee: Hirschmann Automotive GmbH

(21) Appl. No.: 11/493,378

(22) Filed: Jul. 26, 2006

(30) Foreign Application Priority Data
Jul. 27, 2005 (DE) 202005011781.1

(51) Int. Cl. F16D 66/00

(52) U.S. Cl. 188/1.11 E; 188/1.11 R

(57) ABSTRACT

A motor vehicle having a brakeshoe housing that shifts in a predetermined direction relative to a vehicle frame as brakeshoes it carries wear has a brakeshoe-wear monitor with a proximity sensor mounted on the frame and responsive to a position of the brakeshoe housing relative to the direction. Circuitry connected to the sensor evaluates a proximity signal therefrom.

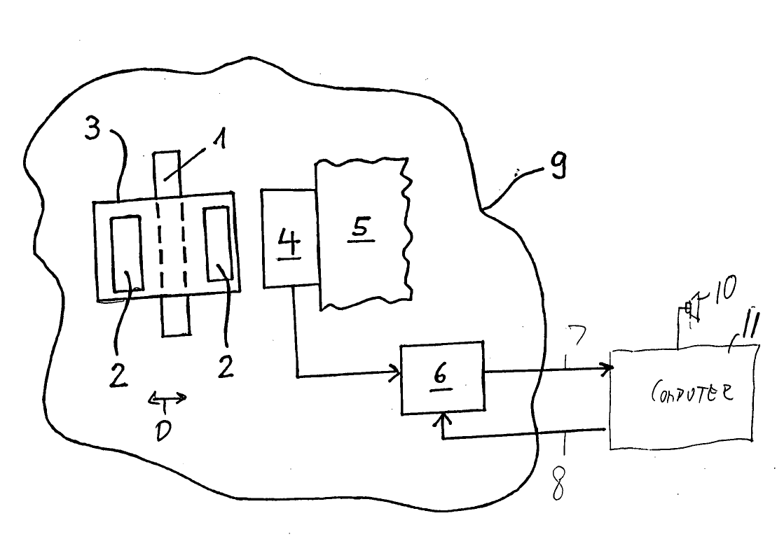

### FIELD OF THE INVENTION

The present invention relates to system for measuring vehicle brakeshoe wear. More particularly this invention concerns such a system that continuously monitors brakeshoe wear.

### BACKGROUND OF THE INVENTION

German patent 41 39 546 of Stumpe describes a system for monitoring vehicle brakeshoe wear in which a sensor is imbedded right in the brakeshoe. It is formed of several parallel somewhat resistive conductors having different lengths. As the brakeshoe wears they are successively worn off so that a circuit connected to them can monitor overall resistance and, when a certain threshold level is reached, generate a warning signal. The output of this system moves in several steps, as wear exposes the succeedingly shorter conductors and they are exposed and shorted out at the brakeshoe face.

Thus here the sensor is worn down with the brakeshoe so that, when the brakeshoe is replaced, the sensor also must be replaced and reconnected to its monitoring circuit. Hence such as system is fairly expensive, mainly because a sensor capable of resisting the extreme stress, in particular high temperatures, that a brakeshoe is subjected to must be employed and replaced. Since the sensor produces an output that varies in discrete steps, the output is not particularly sensitive, but only gives a coarse reading of the actual brakeshoe wear.

Finally this system is subject to installation problems in that an inattentive mechanic might replace the brakeshoe but not make the necessary sensor hookup. This leaves the system wholly inoperative, typically reporting a fault that must be cured by a return visit to the shop. In some situations the system will simply not work at all so the driver will not be informed when his or her brakeshoes are worn out.

### OBJECTS OF THE INVENTION

It is therefore an object of the present invention to provide an improved wear-protected system for monitoring vehicle brakeshoe wear.

Another object is the provision of such an improved wear-protected system for monitoring vehicle brakeshoe wear that overcomes the above-given disadvantages.

### SUMMARY OF THE INVENTION

A motor vehicle having a brakeshoe housing that shifts in a predetermined direction relative to a vehicle frame as brakeshoes it carries wear has a brakeshoe-wear monitor with a proximity sensor mounted on the frame and responsive to a position of the brakeshoe housing relative to the direction. Circuitry connected to the sensor evaluates a proximity signal therefrom.

Thus with this system the wear monitor is a permanent part of the vehicle, not a sacrificial part of the brakeshoe. Furthermore it is mounted at a slight remove from the brake caliper or housing, so that it is not subject to the serious thermal stresses as the brakeshoe. Since the monitor remains in place, even when the brakeshoes are changed, it can be a quality unit counted on to have a long service life. As the brake housing is metallic, typically a casting, it is relatively easy to detect it and the distance from it with a standard proximity sensor.

According to the invention the proximity sensor is fixed adjacent a vehicle wheel, typically right on the axle adjacent the brake housing. The circuitry and proximity sensor are both mounted in a vehicle wheel well. Furthermore the circuitry emits a signal when the detected position exceeds a predetermined threshold value.

In accordance with the invention the brakeshoe position is measured continuously relative to a fixed point on the frame. The fixed point is fixed relative to an axle of a wheel associated with the brakeshoe housing. This makes it possible for the car computer to respond to an out-of-the-ordinary event better, in that it will know for example if all of a sudden brakeshoe wear increases dramatically, due for instance to a locked brake, or does not increase at all, due for instance to a nonfunctioning brake, and is not simply waiting for the next threshold signal as in the '546 patent.

The circuitry according to the invention compares the position detected with a set-point signal and emits an alarm when the detected position passes the set-point signal.

### BRIEF DESCRIPTION OF THE DRAWING

The above and other objects, features, and advantages will become more readily apparent from the following description, reference being made to the accompanying drawing whose sole figure is a largely schematic diagram illustrating the instant invention.

### SPECIFIC DESCRIPTION

As seen in the drawing a brake disk 1 is flanked by a pair of brakeshoes 2 held in a standard brake saddle or caliper 3 that is carried on a vehicle frame 5 and that can move limitedly in a direction D parallel to a rotation axis of the disk 1. Typically one brakeshoe 2 is fixed in the caliper or housing 3 and the other is hydraulically shifted therein in the direction D. Thus as the brakeshoes 2 wear, the housing 3 assumes a normal rest position between actuations that shifts in the direction D away from the fixed shoe 2.

According to the invention a proximity sensor 4 is carried on the vehicle frame 5 that also carries the shiftable brake housing 3. This sensor reports to a controller 6 the distance of the brake housing 3 from the vehicle body 5, which is an accurate measure of brakeshoe wear. In turn the controller 6 can emit, when shoe wear exceeds a predetermined limit fed in at 8, a warning as indicated at 7.

A computer 11, which can also be responsible for antilock-braking operation, feeds in the set point at 8 and receives the warning 7, and can be connected to a beeper or warning light 10 to indicate to the vehicle operator when brakeshoe wear has exceeded the predetermined threshold.

Typically the sensor 4 and the local controller 6 are both mounted right in a wheel well 9 of the vehicle, and can in fact form an integrated potted unit.

The system needs merely to be reset when the brakeshoes are replaced. Thus when new shoes are installed, the sensor 4 takes a reading from which is subtracted the shoe thickness to determine a point at which a low-brakeshoe signal is to be emitted. With this system there is a constant monitoring of the brakeshoe wear, not just response at several threshold levels as in the above-discussed '546 patent.

We claim:

1. In a motor vehicle having a brakeshoe housing that shifts in a predetermined direction relative to a vehicle frame, a brakeshoe-wear monitor comprising:
a proximity sensor mounted on the frame and responsive to a position of the brakeshoe housing relative to the direction; and
circuit means connected to the sensor for evaluating a proximity signal therefrom.

2. The brakeshoe-wear monitor defined in claim 1 wherein the proximity sensor is fixed adjacent a vehicle wheel.

3. The brakeshoe-wear monitor defined in claim 1 wherein the circuit means emits a signal when the detected position exceeds a predetermined threshold value.

4. The brakeshoe-wear monitor defined in claim 1 wherein the circuit means and proximity sensor are both mounted in a vehicle wheel well.

5. The brakeshoe-wear monitor defined in claim 1 wherein the brakeshoe position is measured continuously relative to a fixed point on the frame.

6. The brakeshoe-wear monitor defined in claim 5 wherein the fixed point is fixed relative to an axle of a wheel associated with the brakeshoe housing.

7. The brakeshoe-wear monitor defined in claim 1 wherein the circuit means compares the position detected with a set-point signal.

8. The brakeshoe-wear monitor defined in claim 7 wherein the circuit means emits an alarm when the detected position passes the set-point signal.
